(19) United States
(12) Patent Application Publication
(10) Pub. No.: US 2014/0295906 A1
(43) Pub. Date: Oct. 2, 2014

(54) METHOD AND APPARATUS FOR SELECTING A POWER CONTROL MODE IN A COMMUNICATION SYSTEM

(71) Applicant: Samsung Electronics Co., Ltd., Gyeonggi-do (KR)

(72) Inventors: Jun-Hyung KIM, Gyeonggi-do (KR); Mayuresh Madhukar Patil, Gyeonggi-do (KR); Jong-Hyo Lee, Gyeonggi-do (KR); Ji-Hye Lee, Seoul (KR); Se-Hee Han, Seoul (KR)

(73) Assignee: Samsung Electronics Co., Ltd., Gyeonggi-do (KR)

(21) Appl. No.: 14/230,368

(22) Filed: Mar. 31, 2014

(30) Foreign Application Priority Data
Mar. 29, 2013 (KR) 10-2013-0034637

(51) Int. Cl. H04W 52/38

(52) U.S. Cl. CPC H04W 52/38
USPC 455/522

(57) ABSTRACT

A host for setting a power control mode in a wireless communication system, and a method thereof, are provided. The host determines a type of at least one device, selects a first power control mode based on the type of the device, transmits, to the device, a first power control message including the selected first power control mode, selects a second power control mode based on a video to be played back, and transmits, to the device, a second power control message including the selected second power control mode. A device for setting a power control mode in a wireless communication system, and a method thereof, are also provided.

### PRIORITY

This application claims priority under 35 U.S.C. §119(a) to Korean Application Serial No. 10-2013-0034637, which was filed in the Korean Intellectual Property Office on Mar. 29, 2013, the entire content of which is incorporated herein by reference.

### BACKGROUND

1. Field of the Invention

The present invention generally relates to a method and apparatus for selecting a power control mode in a wireless communication system.

2. Description of the Related Art

For communication in a wireless network environment, there is a need for a wireless interface for wirelessly connecting each network device. As a wireless interface, infrared communication, Bluetooth, and the like are applied to products, and recently, studies on a Wireless universal Serial Bus (WSB) have been conducted so as to wirelessly use a Universal Serial Bus (USB) which is a part of the conventional wired networks.

The USB is a type of a serial port, and is a standardized wired interface that is developed for connecting a computer with a peripheral device such as a mouse, a printer, a modem, a speaker, and the like. The USB has merits over other wired interfaces, and thus has been widely applied as a standard equipment of a Personal Computer (PC). Recently, a USB port has been used for transmitting data from a cellular phone or a digital camera to the PC.

Therefore, use of the USB that executes wired access has been increased and use of the WSB that executes wireless access has also been increased. The WSB includes a Human Interface Device (HID), an audio device, a video device, a Mass-Storage device Class (MSC) device, a Media Transfer Protocol (MTP) device, and the like.

For the HID, an idle time, rather than power consumption, needs to be secured. For audio and video, data scheduling of a host needs to be predictable since a data transmission period is regular although it may be changed based on a codec. For the MSC and the MTP, power consumption, rather than the idle time, needs to be secured.

Meanwhile, a Peer-to-Peer (P2P) scheme shares files among peers, and does not distinguish between a server and a client. Each peer operates as a transmitter or a receiver based on a situation. When the P2P scheme is used, a load may not be intensified in a predetermined server and an overall throughput may be improved using various peers over a network.

Also, a WSB that acts as a Group Owner (GO) in a P2P power control mode is a mobile device, and consumes a great amount of power, and thus may require a power mechanism that optimizes power consumption. However, for the WSB that acts as the GO, a power mechanism that is optimized for each type of a plurality of WSB devices is not performed. When compared to the conventional wired connection USB, a wireless connection host consumes a greater amount of power, and thus a User Experience (UX) of a user who uses the conventional USB service decreased.

### SUMMARY

The present invention has been made to address at least the problems and disadvantages described above, and to provide at least the advantages describe below.

Accordingly, an aspect of the present invention is to provide a method and apparatus for selecting a power control mode in a wireless communication system.

Another aspect of the present invention is to provide a method and apparatus for a USB host to select a power control mode optimized for a USB device in a wireless communication system.

Another aspect of the present invention is to provide a method and apparatus for controlling power of a USB host and a USB device in a wireless communication system.

Another aspect of the present invention is to provide a method and apparatus for reducing power consumption of a USB host and a USB device in a wireless communication system.

Another aspect of the present invention is to provide, a USB host that detects a required response speed of a USB device, periodicity of data, and a type of the USB device, so as to select a power control mode optimized for the USB device.

Another aspect of the present invention is to provide, a USB device that switches a sleep mode to an active mode based on regular intervals based on a schedule for a USB host to send data, and the USB host induces the USB device to not transmit data when the USB host is in a sleep mode, to reduce power consumption.

In accordance with an aspect of the present invention, a method is provided. The method includes determining a type of at least one device; selecting a first power control mode based on the type of the device; transmitting, to the device, a first power control message including the selected first power control mode; selecting a second power control mode based on a video to be played back; and transmitting, to the device, a second power control message including the selected second power control mode.

In accordance with another aspect of the present invention, a method for at least one device to set a power control mode in a wireless communication system is provided. The method includes receiving, from a host, a first power control message including a first power control mode; setting the first power control mode based on the first power control message; receiving, from the host, a second power control message including a second power control mode; and switching a power control mode from the first power control mode to the second power control mode, based on the second power control message.

In accordance with another aspect of the present invention, a method for a host to set a power control mode in a wireless communication system is provided. The method includes determining a type of at least one device; selecting a first power control mode based on the type of the device; transmitting, to the device, a first power control message including the selected first power control mode; playing back a video; selecting a second power control mode based on the video being played back; and transmitting, to the device, a second power control message including the selected second power control mode.

In accordance with another aspect of the present invention, a host for setting a power control mode in a wireless communication system is provided. The host includes a transmitting unit; and a controller to determine a type of at least one device, to select a first power control mode based on the type of the device, to transmit, to the device, a first power control message including the selected first power control mode, to select a second power control mode based on a video to be played back, and that controls the transmitting unit to transmit, to the device, a second power control message including the selected second power control mode.

In accordance with another aspect of the present invention, a device for setting a power control mode in a wireless communication system is provided. The device includes a receiving unit; and a controller that receives, from a host through the receiving unit, a first power control message including a first power control mode, sets the first power control mode based on the first power control message, receives, from the host, a second power control message including a second power control mode, and switches a power control mode from the first power control mode to the second power control mode based on the second power control message.

In accordance with another aspect of the present invention, a host for setting a power control mode in a wireless communication system is provided. The host includes a transmitting unit; and a controller to determine a type of at least one device, to select a first power control mode based on a type of the device, to transmit, to the device, a first power control message including the selected first power control mode, to play back a video, to select a second power control mode based on the video being played back, that controls the transmitting unit to transmit a second power control message including the selected second power control mode to the device.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram of a wireless communication system according to embodiments of the present invention;

FIG. 2 is a signaling flowchart illustrating a process of selecting a power control mode in a wireless communication system according to a first embodiment of the present invention;

FIG. 3 is a signaling flowchart illustrating a process of selecting a power control mode in a wireless communication system according to a second embodiment of the present invention;

FIG. 4 is a flowchart illustrating an operation of a USB host in a wireless communication system according to a first embodiment of the present invention;

FIG. 5 is a flowchart illustrating an operation of a USB device in a wireless communication system according to a first embodiment of the present invention;

FIG. 6 is a flowchart illustrating an operation of a USB host in a wireless communication system according to a second embodiment of the present invention;

FIG. 7 is a flowchart illustrating an operation of a USB device in a wireless communication system according to the second embodiment of the present invention;

FIG. 8 is a diagram illustrating a structure of a USB host according to an embodiment of the present invention; and

FIG. 9 is a diagram illustrating a structure of a USB device according to an embodiment of the present invention.

### DETAILED DESCRIPTION OF EMBODIMENTS OF THE PRESENT INVENTION

Hereinafter, an operation principle of the present invention will be described in detail with reference to the accompanying drawings. A detailed description of known functions and configurations incorporated herein will be omitted as it may make the subject matter of the present disclosure unclear. Meanwhile, terms described herein are defined in consideration of the functions of the present invention, but the meaning of the terms may be changed according to a user, intention of an operator, or convention. Therefore, the definition needs to be determined based on the overall content of the present specification.

In the present invention, a plurality of USBs may be WSBs, and a power control mode may be selected based on a type of a WSB.

Hereinafter, a method and an apparatus for a USB host according to an embodiment of the present invention to select a power control mode (for example, a duration, an interval, a count, and the like) for each of a plurality of USB devices will be described.

A duration value of the power control mode may be changed for each of the plurality of USB devices. The USB host and each of the plurality of USB devices may be wirelessly connected. Also, the USB host may act as a USB device and the USB device may act as a USB host. The USB host and each of the plurality of USB devices may act as a server and a client.

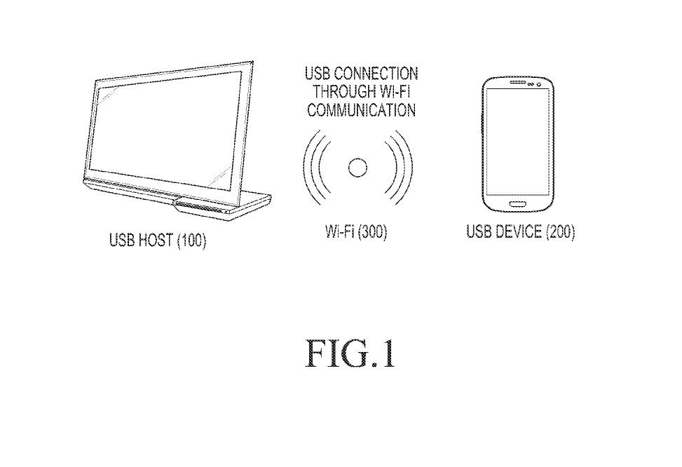

FIG. 1 is a diagram of a wireless communication system according to embodiments of the present invention.

Referring to FIG. 1, the wireless communication system includes a Universal Serial Bus (USB) host 100, a USB device 200, and a Wi-Fi 300.

When the USB host 100 is connected to the USB device 200 through the Wi-Fi 300, the USB host 100 selects a power control mode based on a type of the USB device 200. Subsequently, the USB host 100 transmits a power control message including information associated with the selected power control mode to the USB device 200.

The power control mode may include Notice of Absence, No power save, Opportunistic power save, Force to Doze power save, and the like, and a condition used when the USB host 100 selects the power control mode based on the type of the USB device 200 may be as follows:

1) select a first control mode (for example, Notice of Absence), when power consumption is important;

2) select a second control mode (for example, No power save), when power consumption is not important;

3) select a third control mode (for example, opportunistic power save), when aperiodic data is transmitted; and

4) select a fourth control mode (for example, Force to Doze power save), when data is aperiodically transmitted and dependent data of a host (the USB device 200 is compulsorily maintained in a sleep mode) is transmitted.

When the USB device 200 is connected with the USB host 100 through the Wi-Fi 300, the USB device 200 receives a power control message including information associated with a power control mode from the USB host 100. The USB device 200 enters a power control mode based on the power control message. As another embodiment, the USB device 200 may determine whether to execute a sleep mode based on the first control mode. However, the USB device 200 may be compulsorily switched into a sleep mode based on the fourth control mode. Also, when the USB device 200 enters the sleep mode based on the received power control message, following three operations may be executed:

1) lower power that is being used;

2) turn only a predetermined component off, and maintain a transceiving unit to remain on; and

3) turn all components off.

The USB device 200 includes an HID such as a mouse and a keyboard, an audio and video device such as a webcam, an MSC and MTP that transmit high capacity data, and the like.

The Wi-Fi 300 executes wireless connection between the USB host 100 and the USB device 200.

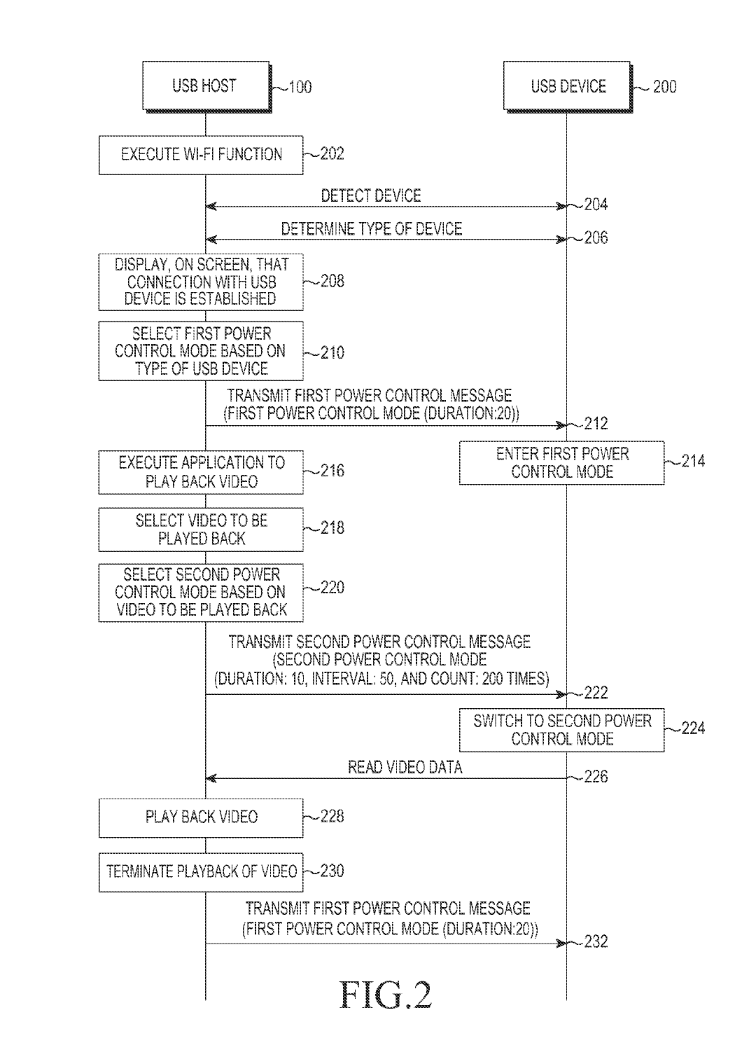

FIG. 2 is a signaling flowchart illustrating a process of selecting a power control mode in a wireless communication system according to a first embodiment of the present invention.

Referring to FIG. 2, in step 202, the USB host 100 executes a Wi-Fi function.

In step 204, the USB host 100 detects the USB device 200 through Wi-Fi. In this example, the USB device 200 may also detect the USB host 100 through Wi-Fi.

In step 206, the USB host 100 determines a type of the detected USB device 200. Although the USB device 200 may be an HID, an audio device, a video device, an MSC, an MTP, and the like, the USB device 200 in the first embodiment of the present invention is a device that stores data such as audio, video, and the like.

In step 208, the USB host 100 displays, on a screen, that the USB host 100 is connected with the USB device 200, so as to inform a user of the connection.

In step 210, the USB host 100 selects a first power control mode (for example, a duration: 20 seconds) based on a type of the USB device 200. A duration value of the power control mode may be changed based on a type of the USB device 200.

The duration value indicates a period in which the USB host 100 maintains a sleep mode state.

In step 212, the USB host 100 transmits, to the USB device 200, a first power control message including information (a duration: 20) associated with the first power control mode.

In step 214, the USB device 200 that receives the first power control message enters the first power control mode (a duration: 20) based on the first power control message. The first power control message includes information that instructs the USB device 200 to maintain a sleep mode. Therefore, the USB device 200 maintains the sleep mode during a duration of 20 when it enters the first power control mode (a duration: 20). Even though the USB device 200 receives a message reporting that it needs to enter the first power control mode (a duration: 20), the USB device 200 may maintain the sleep mode or an active mode during a duration of 20 through the above-described three operations (1), 2), and 3)) that may be executed when the USB device 200 enters the sleep mode.

When a video is to be played back, the USB host 100 executes an application to play back the video in step 216.

In step 218, the USB host 100 selects a video to be played back.

In step 220, the USB host 100 selects a second power control mode (a duration: 10, an interval: 50, and a count: 200 times) based on the video to be played back.

In step 222, the USB host 100 transmits, to the USB device 200, a second power control message including information (for example, a duration: 10, an interval: 50, and a count: 200 times) associated with the second power control mode for the selected video.

The interval indicates a period of a sleep mode state of the USB host 100, and the count indicates a number of times that the USB host 100 is switched from an active mode state to a sleep mode state.

In step 224, the USB device 200 that receives the second power control message switches a power control mode from the first power control mode (a duration: 20) into the second power control mode (a duration: 10, an interval: 50, and a count: 200), based on the second power control message.

The second power control message includes information that requests the USB host 100 to load a video selected by the USB host 100 from the USB device 200, and information that requests the USB device 200 to maintain a sleep mode. However, even though the USB device 200 receives a message reporting that it needs to switch a power control mode from the first power control mode (a duration: 20) into a sleep mode of the second power control mode (a duration: 10, an interval: 50, and a count: 200 times), the USB device 200 may maintain the sleep mode or an active mode during a duration of 20 through the above three operations (1), 2), and 3)) that may be executed when the USB device 200 enters the sleep mode.

In step 226, the USB host 100 reads video data from the USB device 200 based on the information that requests the USB host 100 to load the video selected by the USB host 100 from the USB device 200. Subsequently, in step 228, the USB host 100 plays back the video.

When the playback of the video is terminated in step 230, the USB host 100 transmits again, to the USB device 200, the first power control message including the first power control mode information (a duration: 20) in step 232. Subsequently, the USB device 200 that receives the first power control message including the first power control mode information (a duration: 20) switches a power control mode from the second power control mode (a duration: 10, an interval: 50, and a count: 200) to the first power control mode (a duration: 20).

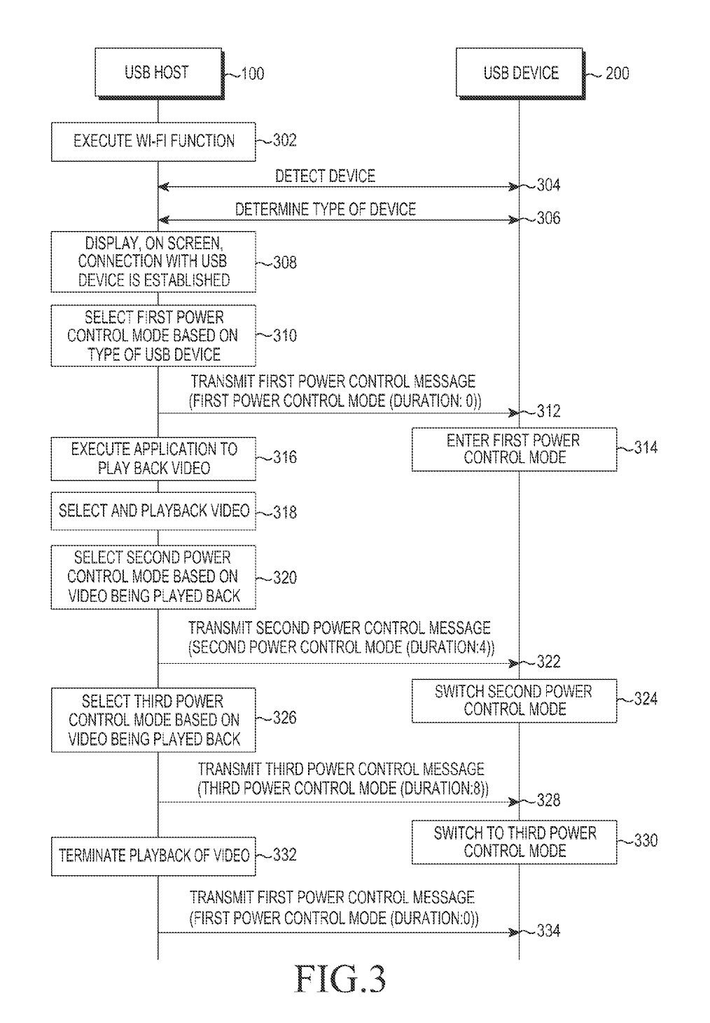

FIG. 3 is a signaling flowchart illustrating a process of selecting a power control mode in a wireless communication system according to a second embodiment of the present invention.

Referring to FIG. 3, in step 302, the USB host 100 executes a Wi-Fi function. In step 304, the USB host 100 detects the USB device 200 through Wi-Fi. In this example, the USB device 200 may also detect the USB host 100 through Wi-Fi.

In step 306, the USB host 100 determines a type of the detected USB device 200. Although the USB device 200 may be an HID, an audio device, a video device, an MSC, an MTP, and the like, the USB device 200 in the second embodiment of the present invention is a device such as a mouse and the like.

In step 308, the USB host 100 displays, on a screen, that the USB host 100 is connected with the USB device 200, so as to inform a user of the connection.

In step 310, the USB host 100 selects a first power control mode (for example, a duration: 0) based on a type of the USB device 200. A duration value of a power control mode may be changed based on a type of the USB device 200.

The duration value indicates a period in which the USB host 100 maintains a sleep mode state.

In step 312, the USB host 100 transmits, to the USB device 200, a first power control message including information (a duration: 0) associated with the first power control mode.

In step 314, the USB device 200 that receives the first power control message enters the first power control mode (a duration: 0) based on the first power control message. Although the USB device 200 enters the first power control mode (a duration: 0), the duration value is 0 and thus, the USB host 100 maintains an active mode as opposed to a sleep mode. The USB host 100 uses 0 for the duration value so as to maintain an active mode since an amount of use of the mouse is great before a video is played back. In conclusion, the duration is a period in which the USB host 100 maintains a sleep mode state and thus, when 0 is used for the duration value, the USB host 100 is not in a sleep mode state. An active mode may be available when the duration value is greater than or equal to the integer 1.

When a video is to be played back, the USB host 100 executes an application to play back the video in step 316.

In step 318, the USB host 100 selects a video to be played back, and plays back the video.

In step 320, the USB host 100 selects a second power control mode (for example, a duration: 4) according to the video being played back.

In step 322, the USB host 100 transmits, to the USB device 200, a second power control message including information (a duration: 4) associated with the second power control mode for the video being played back.

In step 324, the USB device 200 that receives the second power control message switches a power control mode from the first power control mode (a duration: 0) to the second power control mode (a duration: 4). The second power control message may include information that instructs the USB device 200 to maintain a sleep mode. However, even though the USB device 200 receives a message reporting that it needs to switch a power control mode from the first power control mode (a duration: 0) into a sleep mode of the second power control mode (a duration: 4), the USB device 200 may maintain the sleep mode or an active mode during the duration of 4 through the above three operations (1), 2), and 3)) that may be executed when the USB device 200 enters the sleep mode.

When the video being played back is not terminated, the USB host 100 selects a third power control mode (for example, a duration: 8) according to the video being played back in step 326.

In step 328, the USB host 100 transmits, to the USB device 200, a third power control message including information (a duration: 8) associated with the third power control mode for the video being played back.

In step 330, the USB device 200 that receives the third power control message switches a power control mode from the second power control mode (a duration: 4) into the third power control mode (a duration: 8), based on the third power control message. The third power control message may include information that instructs the USB device 200 to maintain a sleep mode. However, even though the USB device 200 receives a message reporting that it needs to switch a power control mode from the second power control mode (a duration: 4) into a sleep mode of the third power control mode (a duration: 8), the USB device 200 may maintain the sleep mode or an active mode during a duration of 8 through the above three operations (1), 2), and 3)) that may be executed when the USB device 200 enters the sleep mode.

Although the duration is specified to be 4 and 8, it may not be limited thereto. A duration of a selected control mode until the playback of the video is terminated may increase. That is, when a playback time increases based on a video, a number of times a mouse is used gradually decreases. A power control mode may be continuously selected so as to increase a period of a sleep mode until the playback of the video is terminated.

When the playback of the video is terminated in step 332, the USB host 100 transmits again, to the USB device 200, the first power control message including the first power control mode information (a duration: 0) in step 334. Subsequently, the USB device 200 that receives the first power control message including the first power control mode information (a duration: 0) switches a power control mode from the third power control mode (a duration: 8) to the first power control mode (a duration: 0).

In the second embodiment, the power control mode information may not be limited to a duration, and may include a count and an interval as power control mode information in the same manner as the first embodiment.

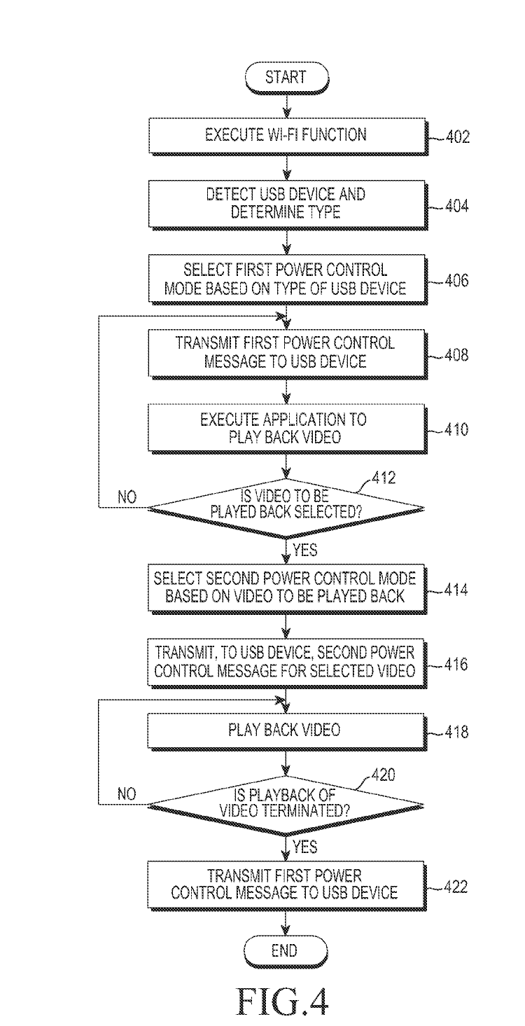

FIG. 4 is a flowchart illustrating an operation of a USB host in a wireless communication system according to a first embodiment of the present invention.

Referring to FIG. 4, in step 402, the USB host 100 executes a Wi-Fi function.

In step 404, the USB host 100 detects the USB device 200 through Wi-Fi, and determines a type of the USB device 200.

In step 406, the USB host 100 displays, on a screen, that the USB host 100 is connected with the USB device 200 so as to inform a user of the connection, and selects a first power control mode (for example, a duration: 20) based on the type of the USB device 200.

In step 408, the USB host 100 transmits, to the USB device 200, a first power control message including information (a duration: 20) associated with the first power control mode. In this example, the first power control message may include information that instructs the USB device 200 to maintain a sleep mode.

In step 410, the USB host 100 executes an application to play back a video. In step 412, the USB host 100 determines whether a video is selected to be played back. When the USB host 100 does not select a video to be played back in step 412, the USB host 100 returns to step 408 and transmits again, to the USB device 200, the first power control message including the first power control mode information (a duration: 20).

When the USB host 100 selects a video to be played back in step 412, the USB host 100 selects a second power control mode based on the selected video in step 414.

In step 416, the USB host 100 transmits, to the USB device 200, a second power control message including information (a duration: 10, an interval: 50, and a count: 200 times) associated with the second power control mode optimized for the selected video. The second power control message may include information that instructs playback of a video, and information that requests the USB device 200 to maintain a sleep mode.

In step 418, the USB host 100 plays back the selected video. In step 420, the USB host 100 determines whether playback of the video is terminated. When the playback of the selected video is not terminated in step 420, the USB host 100 returns to step 418 and continues to play back the video. When the playback of the selected video is terminated in step 420, the USB host 100 transmits again, to the USB device 200, the first power control message including the information (a duration: 20) associated with the first power control mode in step 422.

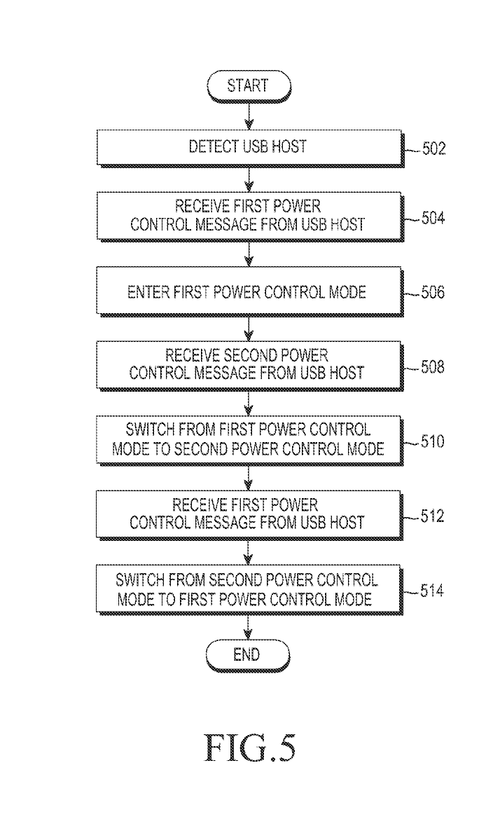

FIG. 5 is a flowchart illustrating an operation of a USB device in a wireless communication system according to a first embodiment of the present invention.

Referring to FIG. 5, the USB device 200 detects the USB host 100 through a Wi-Fi function in step 502.

When the USB device 200 receives a first power control message including first power control mode information (for example, a duration: 20) from the USB host 100 in step 504, the USB device 200 enters the first power control mode in step 506. The entry into the first power control mode indicates that the USB device 200 maintains a sleep mode during a duration of 20. However, even though the USB device 200 receives a message reporting that it needs to enter the first power control mode (a duration: 20), the USB device 200 may maintain a sleep mode or an active mode during a duration of 20 through the above three operations (1), 2), and 3)) that may be executed when the USB device 200 enters the sleep mode.

When the USB device 200 receives a second power control message including second power control mode information (for example, a duration: 10, an interval: 50, and a count: 200) from the USB host 100 in step 508, the USB device 200 switches a power control mode from the first power control mode (a duration: 20) to a second power control mode (a duration: 10, an interval: 50, and a count: 200) in step 510. However, even though the USB device 200 receives a message reporting that it needs to switch a power control mode from the first power control mode (a duration: 20) to a sleep mode of the second power control mode (a duration: 10, an interval: 50, and a count: 200), the USB device 200 may maintain a sleep mode or an active mode during a duration of 10, at an interval of 50, and a count of 200 times through the above three operations (1), 2), and 3)) that may be executed when the USB device 200 enters the sleep mode.

When the USB device 200 does not receive the first power control message including the first power control mode information (a duration: 20) in step 512, the USB device 200 maintains the second power control mode state.

When the USB device 200 receives the first power control message including the first power control mode information (a duration: 20) in step 512, the USB device 200 switches a power control mode from the second power control mode (a duration: 10, an interval: 50, and a count: 200) to the first power control mode (a duration: 20) in step 514.

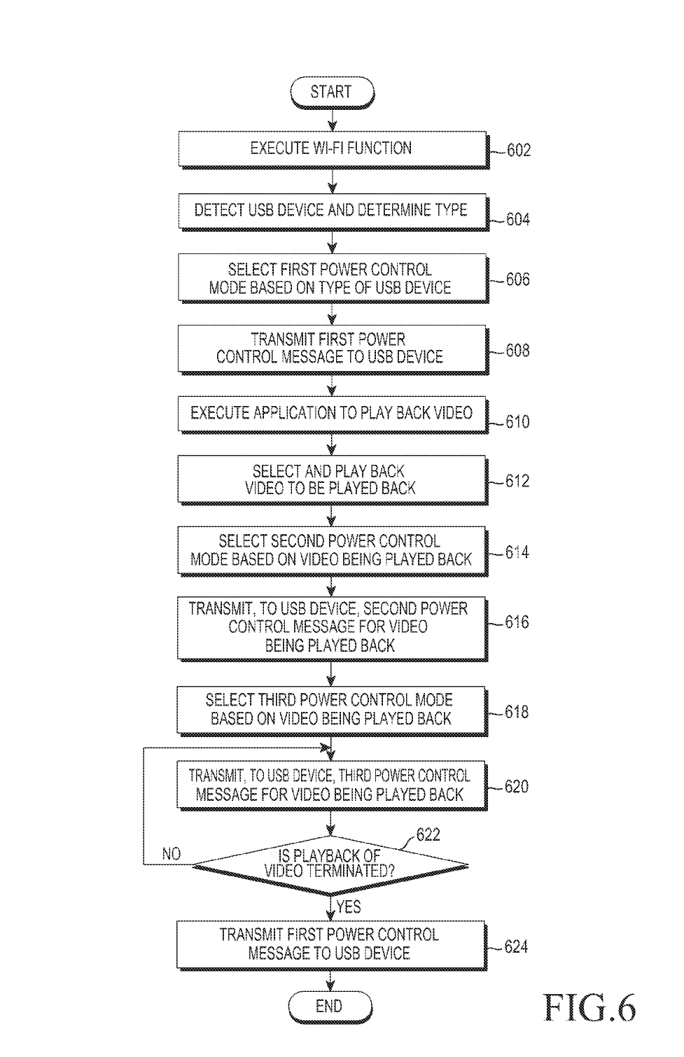

FIG. 6 is a flowchart illustrating an operation of a USB host in a wireless communication system according to a second embodiment of the present invention.

Referring to FIG. 6, in step 602, the USB host 100 executes a Wi-Fi function.

In step 604, the USB host 100 detects the USB device 200 through Wi-Fi, and determines a type of the USB device 200.

In step 606, the USB host 100 displays, on a screen, that the USB host 100 is connected with the USB device 200, so as to inform a user of the connection, and selects a first power control mode based on the type of the USB device 200.

In step 608, the USB host 100 transmits, to the USB device 200, a first power control message including first power control mode information (for example, a duration: 0).

In step 610, the USB host 100 executes an application to play back a video. In step 612, the USB host 100 determines whether to select a video to be played back. When the USB host 100 does not select a video to be played back in step 612, the USB host 100 returns to step 608 and transmits again, to the USB device 200, the first power control message including the first power control mode information (a duration: 0).

When the USB host 100 selects a video to be played back and plays back the video in step 612, the USB host 100 selects a second power control mode (for example, a duration: 4) based on the video being played back in step 614.

In step 616, the USB host 100 transmits, to the USB device 200, a second power control message including information (a duration: 4) associated with the second power control mode for the selected video. The second power control message may also include information that requests the USB device 200 to maintain a sleep mode.

When the video being played back is not terminated, the USB host 100 selects a third power control mode (for example, a duration: 8) based on the video being played back in step 618.

In step 620, the USB host 100 transmits, to the USB device 200, a third power control message including information (a duration: 8) associated with the third power control mode for the video being played back.

The USB host 100 determines whether the playback of the video is terminated in step 622. When the playback of the video being played back is not terminated in step 622, the USB host 100 returns to step 620. When the playback of the video is terminated in step 622, the USB host 100 transmits again, to the USB device 200, the first power control message including the first power control mode information (a duration: 0) in step 624.

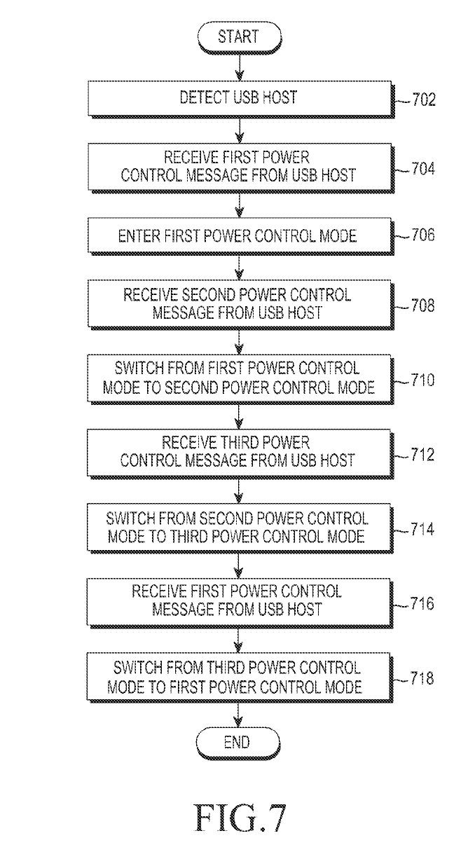

FIG. 7 is a flowchart illustrating an operation of a USB device in a wireless communication system according to the second embodiment of the present invention.

Referring to FIG. 7, the USB device 200 detects the USB host 100 through a Wi-Fi function.

When the USB device 200 receives a first power control message including first power control mode information (for example, a duration: 0) from the USB host 100 in step 704, the USB device 200 enters a first power control mode in step 706.

When the USB device 200 receives a second power control message including second power control mode information (for example, a duration: 4) from the USB host 100 in step 708, the USB device 200 switches a power control mode from the first power control mode (a duration: 0) to a second power control mode (a duration: 4) in step 710. However, even though the USB device 200 receives a message reporting that it needs to switch a power control mode from the first power control mode (a duration: 0) to a sleep mode of the second power control mode (a duration: 4), the USB device 200 may maintain a sleep mode or an active mode during a duration of 4 through the above three operations (1), 2), and 3)) that may be executed when the USB device 200 enters the sleep mode.

When the USB device 200 receives a power control message including third power control mode information (for example, a duration: 8) from the USB host 100 in step 712, the USB device 200 switches a power control mode from the second power control mode (a duration: 4) to a third power control mode (a duration: 8) in step 714. However, even though the USB device 200 receives a message reporting that it needs to switch a power control mode from the second power control mode (a duration: 4) to a sleep mode of the third power control mode (a duration: 8), the USB device 200 may maintain a sleep mode or an active mode during a duration of 4 through the above three operations (1), 2), and 3)) that may be executed when the USB device 200 enters the sleep mode.

In step 716, the USB device 200 determines whether it has received the first power control message (duration: 0) from the USB host 100. When the USB device 200 does not receive the first power control message including the first power control mode information (a duration: 0) in step 716, the USB device 200 remains in to step 716 and maintains the third power control mode state (a duration: 8).

When the USB device 200 receives the first power control message including the first power control mode information (a duration: 0) in step 716, the USB device 200 switches a power control mode from the third power control mode (a duration: 8) to the first power control mode (duration: 0) in step 718.

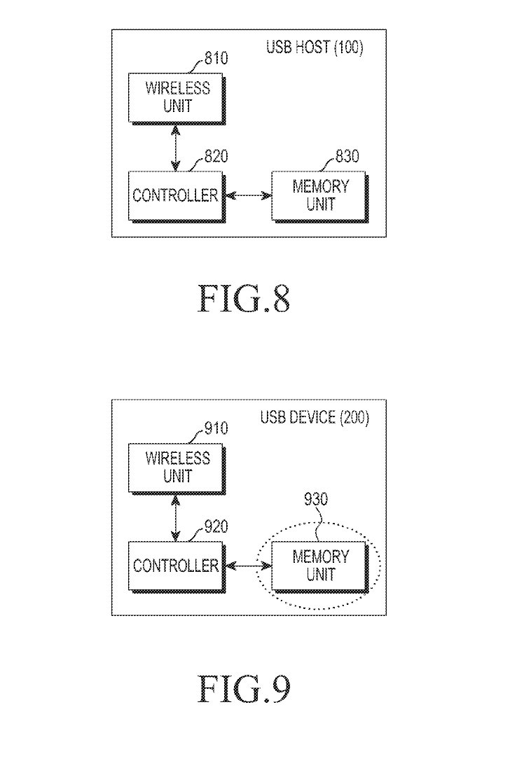

FIG. 8 is a diagram illustrating a structure of a USB host according to an embodiment of the present invention.

Referring to FIG. 8, the USB host 100 includes a wireless unit 810, a controller 820, and a memory unit 830.

The wireless unit 810 transmits, to the USB device 200, a message including control mode information optimized for a type of the USB device 200 detected through Wi-Fi, and transmits and receives data to/from the USB device 200.

The controller 820 sets a first power control mode and a power control mode optimized for the detected USB device 200, and generates a message including information associated with the optimized first power control mode and the optimized power control mode. Also, the controller 820 executes a video playback application so as to select a video to be played back and to play back the video. The controller 820 controls the wireless unit 810 and the memory unit 830, and controls general operations of the USB host 100.

The memory unit 830 stores information associated with the USB device 200 and data, including video data, received from the USB device 200.

FIG. 9 is a diagram illustrating a structure of a USB device according to an embodiment of the present invention.

Referring to FIG. 9, the USB device 200 includes a wireless unit 910, a controller 920, and a memory unit 930.

The wireless unit 910 receives a message including control mode information from the USB host 100 detected through Wi-Fi, and transmits and receives data to/from the USB host 100.

The controller 920 sets an optimized first power control mode and an optimized power control mode when a message including information associated with the optimized first power control mode and the optimized power control mode is received from the USB host 100. The controller 920 controls the wireless unit 910 and the memory unit 930, and controls general operations of the USB device 200.

The memory unit 930 stores information associated with the USB host 100 and information associated with a message received from the USB host 100.

Various embodiments of the present invention have been described above with reference to the accompanying drawings. Although specific embodiments have been described in the detailed descriptions of the present invention, it is apparent that various modifications may be carried out without departing from the scope of the present invention. Therefore, the scope of the present invention should not be defined as being limited to the embodiments, but should be defined by the appended claims and equivalents thereof.

What is claimed is:

1. A method for a host to set a power control mode in a wireless communication system, the method comprising:
determining a type of at least one device;
selecting a first power control mode based on the type of the at least one device;
transmitting, to the at least one device, a first power control message including the selected first power control mode;
selecting a second power control mode based on a video to be played back; and
transmitting, to the at least one device, a second power control message including the selected second power control mode.

2. The method of claim 1, wherein the first power control mode is a power control mode corresponding to a device selected from among the at least one device, and control mode information determined based on a type of the selected device includes at least one of an interval, a count, and a duration.

3. The method of claim 1, wherein the second power control mode is a power control mode corresponding to the video to be played back, and control mode information determined based on a type of the video to be played back includes at least one of an interval, a count, and a duration.

4. The method of claim 1, further comprising:
executing an application to play back the video.

5. The method of claim 1, wherein the host corresponds to a Universal Serial Bus (USB) host.

6. The method of claim 1, wherein the at least one device corresponds to a USB device.

7. The method of claim 1, further comprising:
receiving data from the at least one device and playing back a video.

8. The method of claim 7, wherein, when the playback of the video is terminated, the method further comprises:
transmitting, to the device, the first power control message including the first power control mode.

9. A method for at least one device to set a power control mode in a wireless communication system, the method comprising:
receiving, from a host, a first power control message including a first power control mode;
setting the first power control mode based on the first power control message;
receiving, from the host, a second power control message including a second power control mode; and
switching a power control mode from the first power control mode to the second power control mode, based on the second power control message.

10. The method of claim 9, wherein the first power control mode is a power control mode corresponding to a device selected from among the at least one device, and control mode information determined based on a type of the selected device includes at least one of an interval, a count, and a duration.

11. The method of claim 9, wherein the second power control mode is a power control mode corresponding to a video to be played back, and control mode information determined based on a type of the video to be played back includes at least one of an interval, a count, and a duration.

12. The method of claim 9, wherein the host corresponds to a Universal Serial Bus (USB) host.

13. The method of claim 9, wherein the at least one device corresponds to a USB device.

14. The method of claim 9, further comprising:
transmitting video data to the host.

15. The method of claim 9, further comprising determining whether the first power control message is again received from the host when the power control mode is the second power control mode, wherein, when the first power control message including the first power control mode is received from the host, the power control mode is switched from the second power control mode to the first power control mode, based on the first power control message.

16. A method for a host to set a power control mode in a wireless communication system, the method comprising:
determining a type of at least one device;
selecting a first power control mode based on the type of the at least one device;
transmitting, to the at least one device, a first power control message including the selected first power control mode;
playing back a video;
selecting a second power control mode based on the video being played back; and
transmitting, to the at least one device, a second power control message including the selected second power control mode.

17. The method of claim 16, further comprising:
selecting a power control mode before the video being played back is terminated.

18. The method of claim 16, wherein the first power control mode is a power control mode corresponding to a device selected from among the at least one device, and control mode information determined based on a type of the selected device includes at least one of an interval, a count, and a duration.

19. The method of claim 16, wherein the second power control mode is a power control mode corresponding to the video being played back, and control mode information determined based on a type of the video being played back includes at least one of an interval, a count, and a duration.

20. The method of claim 16, further comprising selecting a third power control mode based on the video being played back; and transmitting, to the at least one device, a third power control message including the selected third power control mode.

21. The method of claim 20, wherein the third power control mode is a power control mode corresponding to the video being played back, and control information determined based on a type of the video being played back includes at least one of an interval, a count, and a duration.

22. The method of claim 20, wherein, when the playback of the video is terminated, the method further comprises: transmitting, to the at least one device, the first power control message including the first power control mode.

23. The method of claim 16, wherein the host corresponds to a Universal Serial Bus (USB) host.

24. The method of claim 16, wherein the at least one device corresponds to a USB device.

25. The method of claim 16, wherein, when the playback of the video is terminated, the method further comprises:
transmitting, to the at least one device, the first power control message including the first power control mode.

26. A host for setting a power control mode in a wireless communication system, the host comprising:
a transmitting unit; and
a controller configured to determine a type of at least one device, to select a first power control mode based on the type of the at least one device, to transmit, to the device, a first power control message including the selected first power control mode, to select a second power control mode based on a video to be played back, and to control the transmitting unit to transmit, to the at least one device, a second power control message including the selected second power control mode.

27. The host of claim 26, wherein the first power control mode is a power control mode corresponding to a device selected from among the at least one device, and control mode information determined based on the type of the selected device includes at least one of an interval, a count, a duration.

28. The host of claim 26, wherein the second power control mode is a power control mode corresponding to the video to be played back, and control mode information determined based on the video to be played back includes at least one of an interval, a count, and a duration.

29. The host of claim 26, wherein the controller executes an application to play back the video.

30. The host of claim 26, wherein the host corresponds to a Universal Serial Bus (USB) host.

31. The host of claim 26, wherein the at least one device corresponds to a USB device.

32. The host of claim 26, wherein the controller comprises:
a receiving unit that receives data from the at least one device,
wherein the controller plays back a video based on the received data.

33. The host of claim 32, wherein, when the playback of the video is terminated, the controller controls the transmitting unit to transmit, to the at least one device, the first power control message including the first power control mode.

34. A device for setting a power control mode in a wireless communication system, the device comprising:
a receiving unit; and
a controller configured to receive, from a host through the receiving unit, a first power control message including a first power control mode to, set the first power control mode based on the first power control message, to receive, from the host, a second power control message including a second power control mode, and to switch a power control mode from the first power control mode to the second power control mode based on the second power control message.

35. The device of claim 34, wherein the first power control mode is a power control mode corresponding to the device, and control mode information determined based on a type of the device includes at least one of an interval, a count, and a duration.

36. The device of claim 34, wherein the second power control mode is a power control mode corresponding to a video to be played back, and control mode information determined based on the type of the video to be played back includes at least one of an interval, a count, and a duration.

37. The device of claim 34, wherein the host corresponds to a Universal Serial Bus (USB) host.

38. The device of claim 34, wherein the device corresponds to a USB device.

39. The device of claim 34, further comprising:
a transmitting unit that transmits video data to the host.

40. The device of claim 34, wherein, when the first power control message including the first power control mode is again received from the host through the receiving unit while the power control mode is the second power control mode, the controller switches the power control mode from the second power control mode to the first power control mode based on the first power control message.

41. A host for setting a power control mode in a wireless communication system, the host comprising:
a transmitting unit; and
a controller configured to determine a type of at least one device, to select a first power control mode based on a type of the at least one device, to transmit, to the at least one device, a first power control message including the selected first power control mode, to play back a video, to select a second power control mode based on the video being played back, and to control the transmitting unit to transmit, to the at least one device, a second power control message including the selected second power control mode.

42. The host of claim 41, wherein the controller further selects a power control mode before the video being played back is terminated.

43. The host of claim 41, wherein the first power control mode is a power control mode corresponding to a device selected from among the at least one device, and the control mode information determined based on a type of the selected device includes at least one of an interval, a count, and a duration.

44. The host of claim 41, wherein the second power control mode is a power control mode corresponding to the video being played back, and control mode information determined based on a type of the video being played back includes at least one of an interval, a count, and a duration.

45. The host of claim 41, wherein the host corresponds to a Universal Serial Bus (USB) host.

46. The host of claim 41, wherein the at least one device corresponds to a USB device.

47. The host of claim 41, wherein, when the playback of the video is terminated, the controller controls the transmitting unit to transmit, to the at least one device, the first power control message including the first power control mode.
